(19) United States
(12) Patent Application Publication
(10) Pub. No.: US 2007/0211380 A1
(43) Pub. Date: Sep. 13, 2007

(54) Perpendicular magnetic head

(75) Inventors: Hideyuki Akimoto, Kawasaki (JP); Mitsuru Otagiri, Kawasaki (JP); Hiroshi Shirataki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/483,318

(22) Filed: Jul. 7, 2006

(30) Foreign Application Priority Data
Mar. 8, 2006 (JP) 2006-62199

(51) Int. Cl. G11B 5/147

(52) U.S. Cl. 360/126

(57) ABSTRACT

The perpendicular magnetic head is capable of solving the problems of side track erasing and pole erasing. The perpendicular magnetic head of the present invention comprises a write-head, which includes a main magnetic pole emitting magnetic fluxes toward a recording medium. An end face of a pole end is formed into a T-shape. A longitudinal pole section of the pole end is made of a low Bs magnetic thin film, whose end face is formed into a rectangle. A transverse pole section of the pole end is made of a high Bs magnetic thin film, whose end face is formed into a rectangle. The low Bs magnetic thin film and the high Bs magnetic thin film are determined by the formula: (area of the end face of the low Bs magnetic thin film)×(saturation magnetic flux density of the low Bs magnetic thin film)>(area of the end face of the high Bs magnetic thin film)×(saturation magnetic flux density of the high Bs magnetic thin film).

### BACKGROUND OF THE INVENTION

The present invention relates to a perpendicular (vertical) magnetic head, more precisely relates to a perpendicular (vertical) magnetic head comprising a write-head, which has a unique main magnetic pole.

A conventional perpendicular magnetic head of a magnetic disk drive unit is shown in FIG. 5. The magnetic head comprises: a read-head 8, in which an MR element 6 for reproducing data is sandwiched between a lower shielding layer 5 and an upper shielding layer 7; and a write-head 10, in which a write-gap 13 is sandwiched between a main magnetic pole 12 and a return yoke 15. A trailing shield 14, which prevents a magnetic field generated by the main magnetic pole 12 from diffusing toward the return yoke 15, is provided to an end of the return yoke 15. A coil 11 for recording data is provided between the main magnetic pole 12 and the return yoke 15.

The perpendicular magnetic head having the main magnetic pole 12 has problems of (1) side track erasing, which is caused by an end shape of the main magnetic pole 12, and (2) pole erasing, which is caused by residual magnetization of the main magnetic pole 12.

As shown in FIG. 6, skew angles θ are different when an arm 20, which holds the magnetic head, is located in an inner part of a recording medium 22 and in an outer part thereof. The difference of the skew angles θ causes the side track erasing. If an end face of a pole end 12a of the main magnetic pole 12 is formed into a rectangle as shown in FIGS. 7A and 7B, a part of the pole end 12a partially passes an adjacent track (see FIG. 7A), so that S/N ratio of recorded data is lowered and bend of bits are caused. To prevent the side track erasing, the end face of the pole end 12a of the main magnetic pole 12 is formed into an inverted trapezoid (see FIGS. 8A and 8B). With this structure, even if the pole end 12a is inclined by the skew angle, the main magnetic pole 12 does not influence the adjacent track (see Japanese Patent Gazette 2003-242608).

These days, magnetic heads record data with high recording density, and recording media having great coercive forces are used. Thus, it is necessary for write-heads of the magnetic heads to generate great magnetic fields. In perpendicular magnetic heads, main magnetic poles of write-heads are made of magnetic materials having high saturation magnetic flux density (high Bs). By using the magnetic materials having high Bs, the pole erasing is caused. Namely, generic high Bs materials have bad soft magnetic characteristic and great residual magnetization. Therefore, even if no electric current (not on writing process) passes through a coil for recording data, a magnetic field is generated from the main magnetic pole and erases data recorded in a recording medium. To prevent the pole erasing, some conventional perpendicular magnetic heads have write-heads constituted by suitable magnetic materials having suitable Bs values, which cause no pole erasing. But the above described materials frequently have low Bs values, and they often make recording performance of the magnetic head low.

To prevent the side track erasing, the end face of the main magnetic pole is formed into the inverted trapezoid, the main magnetic pole may be processed by ion milling, damascene method, etc. However, it is difficult to precisely shape the end face of the main magnetic pole with a correct taper angle and a correct core width. Variations of sizes of the end face must be occurred, so that production yield must be low.

On the other hand, to prevent the pole erasing, a plurality of magnetic thin films may be layered in the main magnetic pole. However, it is difficult to layer the magnetic thin films by plating. The magnetic thin films may be formed by sputtering, etc., but productivity must be low.

### SUMMARY OF THE INVENTION

The present invention was conceived to solve the above described problems.

An object of the present invention is to provide a perpendicular magnetic head, which is capable of solving the problems of side track erasing and pole erasing and which can be produced by a conventional production method with increasing productivity.

To achieve the object, the present invention has following structures.

Namely, the perpendicular magnetic head of the present invention comprises a write-head, which includes a main magnetic pole emitting magnetic fluxes toward a recording medium, characterized in that an end face of a pole end is formed into a T-shape, that a longitudinal pole section of the pole end is made of a low Bs magnetic thin film, whose end face is formed into a rectangle, that a transverse pole section of the pole end is made of a high Bs magnetic thin film, whose end face is formed into a rectangle and whose saturation magnetic flux density is higher than that of the low Bs magnetic thin film, and that the low Bs magnetic thin film and the high Bs magnetic thin film are determined by the formula: (area of the end face of the low Bs magnetic thin film)×(saturation magnetic flux density of the low Bs magnetic thin film)>(area of the end face of the high Bs magnetic thin film)×(saturation magnetic flux density of the high Bs magnetic thin film).

Note that, the low Bs magnetic thin film means a magnetic thin film whose residual magnetization does not erase data recorded in the recording medium; the high Bs magnetic thin film means a magnetic thin film having high Bs value, which is capable of performing high density recording without considering residual magnetization.

Another perpendicular magnetic head comprises a write-head, which includes a main magnetic pole emitting magnetic fluxes toward a recording medium, characterized in that an end face of a pole end is formed into a T-shape, that a longitudinal pole section of the pole end is made of a low Bs magnetic thin film, whose end face is formed into a rectangle, that a transverse pole section of the pole end is made of a high Bs magnetic thin film, whose end face is formed into a tapered and inverted trapezoid and whose saturation magnetic flux density is higher than that of the low Bs magnetic thin film, and that the low Bs magnetic thin film and the high Bs magnetic thin film are determined by the formula: (area of the end face of the low Bs magnetic thin film)×(saturation magnetic flux density of the low Bs magnetic thin film)>(area of the end face of the higg magnetic thin film)×(saturation magnetic flux density of the high Bs magnetic thin film).

In each of the perpendicular magnetic heads, the low Bs magnetic thin film may be made of a magnetic material whose coercive force in a direction of a hard axis is 5 Oe or less. With this structure, even if the high Bs magnetic thin film is made of the magnetic material having a great Bs, the entire main magnetic pole can have soft magnetic characteristics. FeCo magnetic materials, whose Bs values are 2 T or more, have coercive forces (Hc) of 5 Oe or more. On the other hand, the Bs values of NiFe magnetic materials are 2 T or less, and coercive forces (Hc) thereof are 5 Oe or less. The materials of the low Bs magnetic thin film and the high Bs magnetic thin film may be selected on the basis of suitable Bs values. For example, the Bs value 2 T may be used as a threshold value for selecting the materials of the low Bs magnetic thin film and the high Bs magnetic thin film.

In each of the perpendicular magnetic heads, a width and a height of the longitudinal pole section and those of the transverse pole section may be set by adjusting a skew angle so as not to interfere with an adjacent track. With this structure, side track erasing can be effectively prevented.

In the perpendicular magnetic head of the present invention, the end face of the main magnetic pole is formed into the T-shape, so that side track erasing can be prevented. Since the transverse pole section of the main magnetic pole, which works for writing data, is made of the high Bs magnetic thin film, data can be recorded with high recording density. Further, the longitudinal pole section is made of the low Bs magnetic thin film, which has excellent soft magnetic characteristics, so that pole erasing, which is caused by residual magnetization of the main magnetic pole, can be prevented. Since the end faces of the longitudinal pole section and the transverse pole section are formed into the rectangles, the main magnetic pole can be easily produced.

### BRIEF DESCRIPTION OF THE DRAWINGS

Embodiments of the present invention will now be described by way of examples and with reference to the accompanying drawings, in which:

FIGS. 1A and 1B are explanation views of a main magnetic pole, whose end face is formed into a T-shape;

FIGS. 2A and 2B are explanation views of another main magnetic pole, whose end face is formed into an inverted trapezoid;

FIGS. 3A and 3B are end views of the main magnetic poles shown in FIGS. 1A and 1B and FIGS. 2A and 2B;

FIGS. 4A-4D are explanation views showing a process of producing the main magnetic pole;

FIG. 5 is a sectional view of the conventional perpendicular magnetic head;

FIG. 6 is an explanation view showing the skew angles in the inner part and the outer part of the recording medium;

FIGS. 7A and 7B are explanation views showing a mechanism of the side track erasing and the shape of the end face of the main magnetic pole of the conventional magnetic head; and

FIGS. 8A and 8B are explanation views showing the end face the main magnetic pole of the conventional magnetic head, which is formed into the inverted trapezoid, and a method of preventing the side track erasing.

### DETAILED DESCRIPTION OF THE EMBODIMENTS

Preferred embodiments of the present invention will now be described in detail with reference to the accompanying drawings.

FIGS. 1A and 1B are explanation views of an example of a main magnetic pole 12, which is included in a write-head of the perpendicular (vertical) magnetic head of the present invention. In the present embodiment, an end face of a pole end 12a of the main magnetic pole 12 is formed into a T-shape. The main magnetic pole 12 has a two-layered structure, which is constituted by a low saturation magnetic flux density (low Bs) magnetic thin film 121 and a high saturation magnetic flux density (high Bs) magnetic thin film 122. The pole end 12a is constituted by a longitudinal pole section A, which is made of the low Bs magnetic thin film 121 and which is extended in a direction perpendicular to a parting face between the thin films 121 and 122, and a transverse pole section B, which is made of the high Bs magnetic thin film 122 and which is extended in a direction parallel to the parting face.

The present invention is characterized by the main magnetic pole 12 of the write-head, so the structure of the main magnetic pole 12 will be explained. Perpendicular magnetic heads have various structures, but the present invention can be applied to them. Note that, the basic structure of the perpendicular magnetic head was explained in BACKGROUND OF THE INVENTION with reference to FIG. 5, so explanation will be omitted. The main magnetic pole 12 shown in FIGS. 1A and 1B is the same as the pole end 12a of the main magnetic pole 12 shown in FIG. 5.

In FIGS. 1A and 1B, an end face of the pole end 12a of the main magnetic pole 12 is formed into a T-shape. In comparison with the conventional magnetic head whose end face is formed into a rectangle, a longitudinal pole section B is thinner. Therefore, even if the main magnetic pole 12 is inclined by a skew angle (see FIG. 1A), projecting the main magnetic pole 12 toward an adjacent track can be restrained so that side track erasing can be prevented.

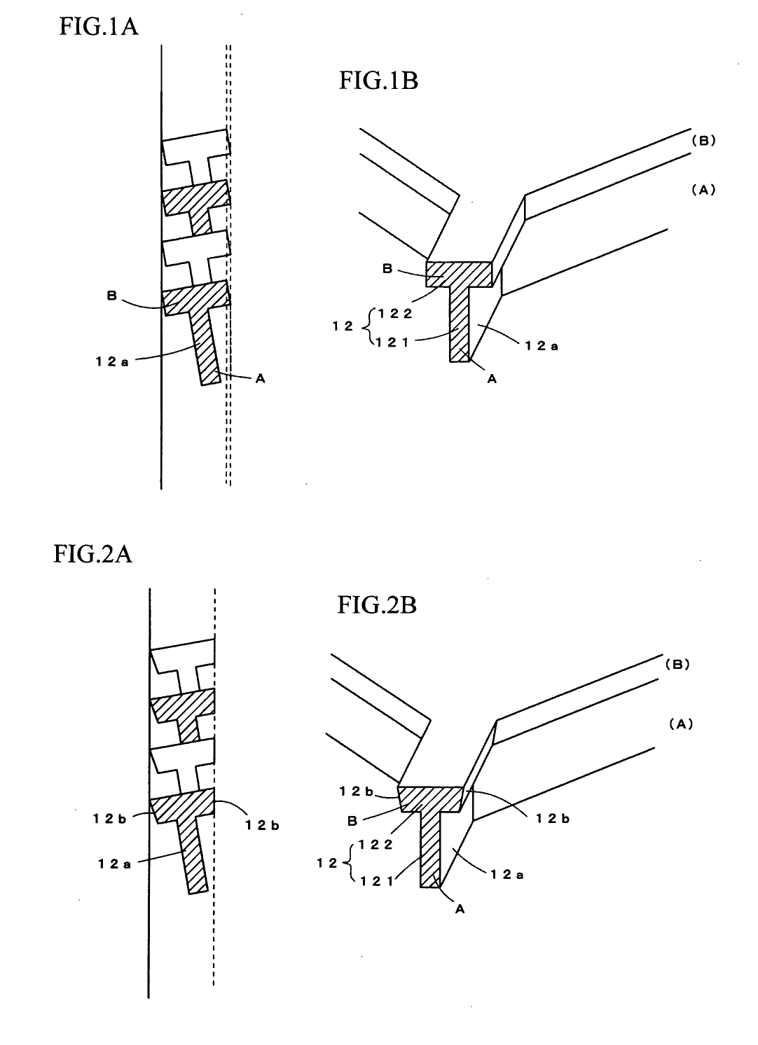

FIGS. 2A and 2B show a modified example of the main magnetic pole 12 whose end face is formed into the T-shape. Side faces of a transverse pole section B of the pole end 12a are sloped, so that the end face of the transverse pole section B is formed into a tapered and inverted trapezoid. With this structure, even if the main magnetic pole 12 is inclined by the skew angle (see FIG. 2A), projecting the main magnetic pole 12 toward the adjacent track can be prevented.

The longitudinal pole section A of the main magnetic pole 12 is made of the low Bs magnetic thin film 121, and the transverse pole section B thereof is made of the high Bs magnetic thin film 122 as well as the example shown in FIGS. 1A and 1B.

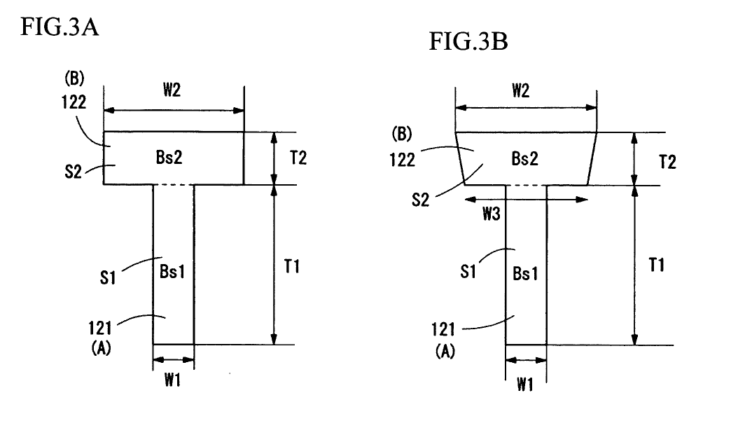

FIG. 3A is an end view of the pole end 12a of the main magnetic pole 12 shown in FIGS. 1A and 1B); FIG. 3B is an end view of the pole end 12a of the main magnetic pole 12 shown in FIGS. 2A and 2B. The longitudinal pole sections A are made of the low Bs magnetic thin film 121; the transverse pole sections B are made of the high Bs magnetic thin film 122.

The low Bs magnetic thin films 121 are made of a magnetic material having excellent soft magnetic characteristics. When no current passes through a coil of the magnetic head, pole erasing is not occurred by residual magnetization of the main magnetic pole 12. For example, the magnetic material having excellent soft magnetic characteristics is a nickel-iron alloy (NiFe). As described above, the low Bs magnetic thin films 121 are made of such magnetic materials having excellent soft magnetic characteristics.

Soft magnetic characteristics of magnetic thin films are generally evaluated by comparing coercive forces (Hc) in hard axis. An experiment of pole erasing was performed with a main magnetic pole, which was constituted by a single film of Fe60Co40 whose Hc was about 10 Oe, and another main magnetic pole, which was constituted by a single film of Ni10Fe90 whose Hc was about 5 Oe. The Ni10Fe90 head did not occur pole erasing, but the Fe60Co40 head occurred pole erasing. According to the results, magnetic materials whose Hc is 5 Oe or less have excellent soft magnetic characteristics, so the magnetic materials whose Hc is 5 Oe or less are effectively used as the materials of the low Bs magnetic thin films 121.

On the other hand, the high Bs magnetic thin films 122 for the write-heads are made of a magnetic material whose Bs value is fully high, e.g., Fe60Co40, so as to highly precisely write data. Materials of the high Bs magnetic thin films 122 are firstly selected to generate high intensity magnetic fields without considering soft magnetic characteristics.

As described above, the transverse pole section B is made of the high Bs magnetic thin film 122, so data are written in a recording medium by magnetic fluxes emitted from an end edge of an upper part of the main magnetic pole 12. Namely, data are written by magnetic fluxes emitted from the transverse pole section B of the main magnetic pole 12. Since the transverse pole section B, which works for writing data, is made of the high Bs magnetic material, data can be effectively written or recorded.

Residual magnetization of the transverse pole section B occurs pole erasing. In the present embodiment, the entire main magnetic pole 12 mainly has the magnetic characteristics of the low Bs magnetic thin film 121, which has excellent soft magnetic characteristics, so as to prevent the pole erasing. Magnetization characteristics of the magnetic thin films are reflected by multiplying volume of the film by a Bs value thereof. To make the function of the low Bs magnetic thin film 121 exceed those of the high Bs magnetic thin film 122, thicknesses of the low Bs film 121 and the high Bs film 122 are determined by the formula: (area of the end face of the low Bs magnetic thin film)×(Bs value of the low Bs magnetic thin film)>(area of the end face of the high Bs magnetic thin film)×(Bs value of the high Bs magnetic thin film).

The pole end 12a of the main magnetic pole 12 is extended with the same sectional shape. Therefore, in the formula, the areas of the end faces of the magnetic thin films 121 and 122 are compared instead of comparing the volumes thereof.

In FIG. 3A, the area of the end face of the longitudinal pole section A is magnetic thin film 121 is Bs1. On the other hand, the area of the end face of the transverse pole section B is S2; a width thereof is W2; a height thereof is T2; and the Bs value of the high Bs magnetic thin film 122 is Bs2. The formula is
S1×BS1>S2×BS2, or (W1×T1)×BS1>(W2×T2)×BS2

In FIG. 3B, the transverse pole section B is formed into the inverted trapezoid. An upper side of the inverted trapezoid is W2; and a lower side thereof is W3. The formula is
(W1×T1)×BS1>((W2+W3)/2×T2)×BS2.

In the entire main magnetic pole 12, the magnetic characteristics of the low Bs magnetic thin film 121 exceed those of the high Bs magnetic thin film 122 as determined by the formula. When no electric current passes through the coil for writing data, the entire main magnetic pole 12 has the soft magnetic characteristics of the low Bs magnetic thin film 121. Namely, the main magnetic pole 12 capable of writing data with the high Bs magnetic thin film 122 without occurring pole erasing can be realized.

The main magnetic pole 12 of the present embodiment can solve the both problems of side track erasing and pole erasing.

In the main magnetic pole 12 shown in FIGS. 3A and 3B, the width W1 and the height T1 of the longitudinal pole section A, the width W2 and the height T2 of the transverse pole section B, etc. are designed with considering the skew angle, so that the pole end 12a of the main magnetic pole 12 does not interfere with the adjacent track of the recording medium.

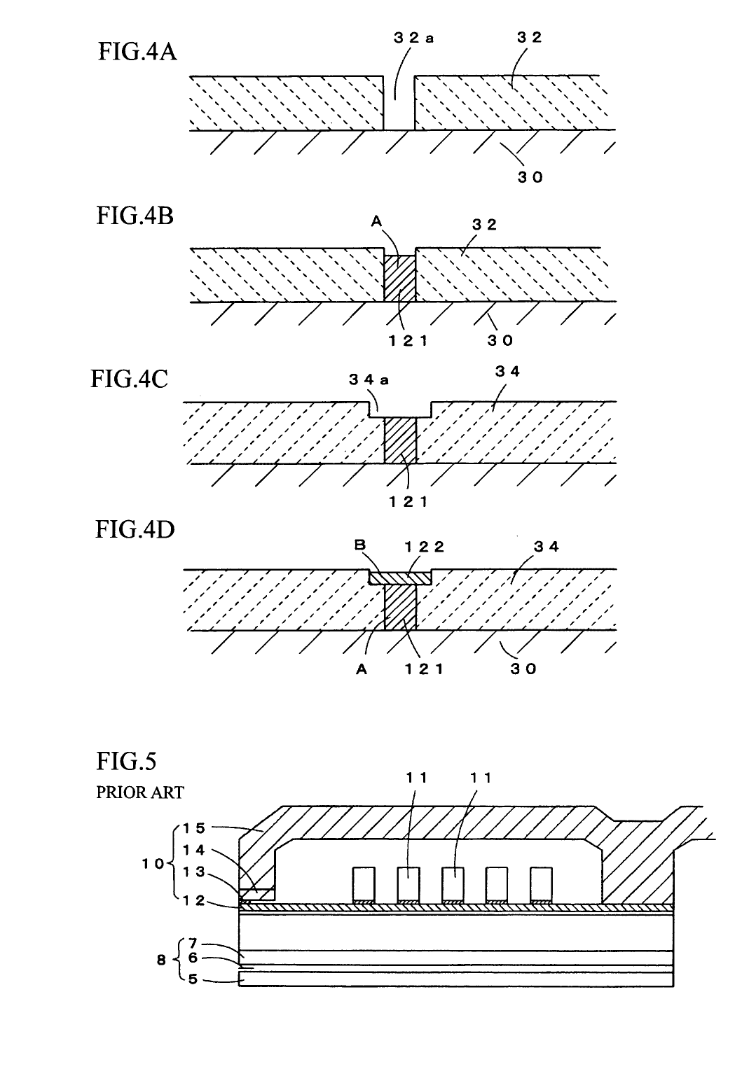

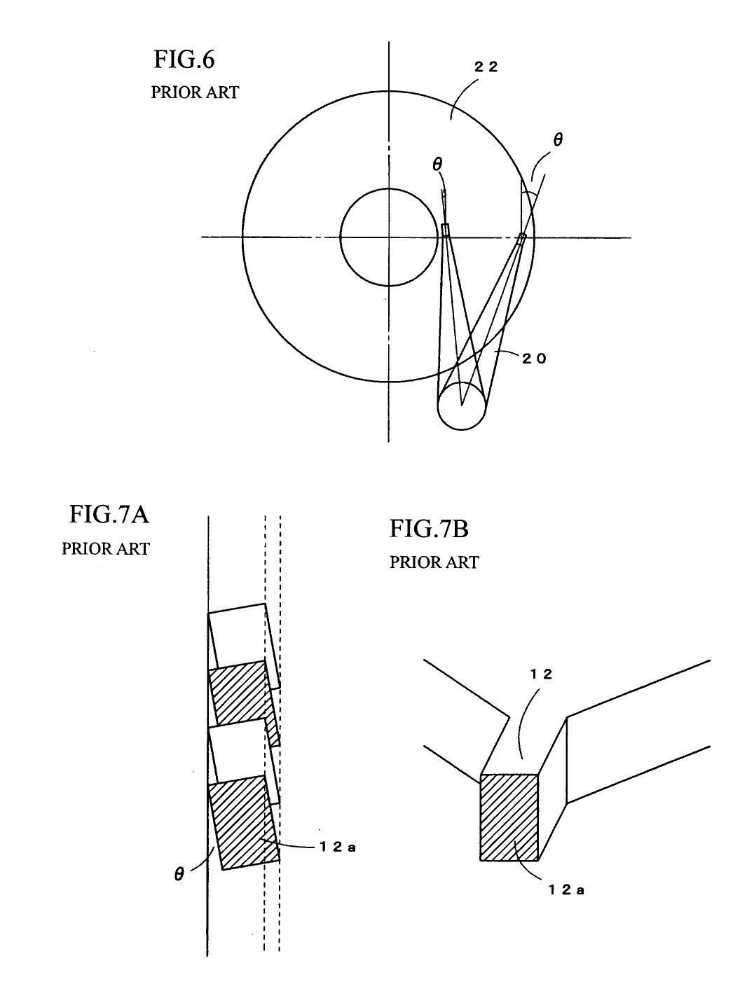

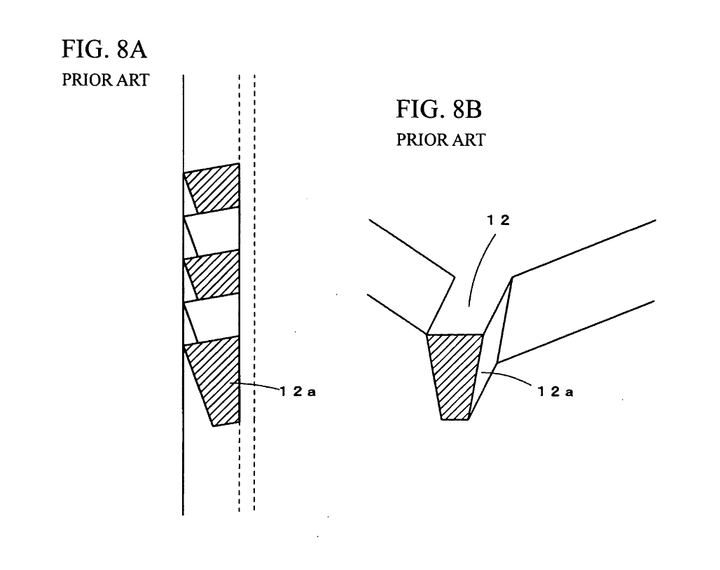

FIGS. 4A-4D show a process of producing the main magnetic pole 12.

In FIG. 4A, a base layer 30 of the main magnetic pole 12 is formed on a surface of a work piece (wafer), the surface is coated with resist 32, and a groove 32a, which corresponds to a pattern of the longitudinal pole section A of the main magnetic pole 12, is formed in the resist 32 by optically exposing and developing.

In FIG. 4B, the inner space of the groove 32a is filled with the low Bs material by plating or sputtering, so that the low Bs magnetic thin film 121, which becomes the longitudinal pole section A, is formed. FIG. 4B, a sectional view of the pole end 12a seen from the end face.

In FIG. 4C, the resist 32 is removed, the surface of the work piece is newly coated with another resist 34, and a groove 34a, which is correctly positioned with respect to the pattern of the longitudinal pole section A of the main magnetic pole 12, is formed in the resist 34.

In FIG. 4D, the inner space of the groove 34a is filled with the high Bs material by plating or sputtering, so that the high Bs magnetic thin film 122, which becomes the transverse pole section B, is formed.

Then, the resist 34 is removed, so that the main magnetic pole 12, whose end face is formed into the T-shape and in which the longitudinal pole section A is made of the low Bs magnetic thin film 121 and the transverse pole section B is made of the high Bs magnetic thin film 122, is produced.

In the described method of producing the main magnetic pole 12, the grooves 32a and 34a are formed by patterning the resist 32 and 34, then the longitudinal pole section A and the transverse pole section B are formed by plating or sputtering. The grooves 32a and 34a formed in the resist 32 and 34 are mere linear grooves having prescribed widths. In comparison with grooves whose inner side faces are formed into female-tapered faces so as to form the pole end into the tapered shape, the grooves 32a and 34a can be formed easily. The process of forming linear grooves in resist is widely employed to produce conventional horizontal magnetic heads. Therefore, the main magnetic head 12 can be produced by the conventional method.

Since the grooves 32a and 34a are linear grooves, manufacturing variations of the main magnetic poles can be restrained. Therefore, the main magnetic poles, each of which has the pole end whose end face is formed into the T-shape, can be correctly produced.

As described above, the end face of the main magnetic pole 12 is formed into the T-shape, so that the perpendicular magnetic head is capable of preventing side track erasing. Further, the transverse pole section B, which works for writing data, is made of the high Bs magnetic material, so that high density recording can be performed; the longitudinal pole section A is made of the magnetic material having excellent soft magnetic characteristics. Therefore, the perpendicular magnetic head is capable of preventing pole erasing, which is caused by residual magnetization of the main magnetic pole 12, too. Further, the main magnetic pole 12 can be produced easily.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A perpendicular magnetic head comprising a write-head, which includes a main magnetic pole emitting magnetic fluxes toward a recording medium, characterized in,
that an end face of a pole end is formed into a T-shape,
that a longitudinal pole section of the pole end is made of a low Bs magnetic thin film, whose end face is formed into a rectangle,
that a transverse pole section of the pole end is made of a high Bs magnetic thin film, whose end face is formed into a rectangle and whose saturation magnetic flux density is higher than that of the low Bs magnetic thin film, and
that the low Bs magnetic thin film and the high Bs magnetic thin film are determined by the formula: (area of the end face of the low Bs magnetic thin film)×(saturation magnetic flux density of the low Bs magnetic thin film)>(area of the end face of the high Bs magnetic thin film)×(saturation magnetic flux density of the high Bs magnetic thin film).

2. A perpendicular magnetic head comprising a write-head, which includes a main magnetic pole emitting magnetic fluxes toward a recording medium, characterized in,
that an end face of a pole end is formed into a T-shape,
that a longitudinal pole section of the pole end is made of a low Bs magnetic thin film, whose end face is formed into a rectangle,
that a transverse pole section of the pole end is made of a high Bs magnetic thin film, whose end face is formed into a tapered and inverted trapezoid and whose saturation magnetic flux density is higher than that of the low Bs magnetic thin film, and
that the low Bs magnetic thin film and the high Bs magnetic thin film are determined by the formula: (area of the end face of the low Bs magnetic thin film)×(saturation magnetic flux density of the low Bs magnetic thin film)>(area of the end face of the high Bs magnetic thin film)×(saturation magnetic flux density of the high Bs magnetic thin film).

3. The perpendicular magnetic head according to claim 1, wherein the low Bs magnetic thin film is made of a magnetic material whose coercive force in a direction of a hard axis is 5 Oe or less.

4. The perpendicular magnetic head according to claim 2, wherein the low Bs magnetic thin film is made of a magnetic material whose coercive force in a direction of a hard axis is 5 Oe or less.

5. The perpendicular magnetic head according to claim 1, wherein a width and a height of the longitudinal pole section and those of the transverse pole section are set by adjusting a skew angle so as not to interfere with an adjacent track.

6. The perpendicular magnetic head according to claim 2, wherein a width and a height of the longitudinal pole section and those of the transverse pole section are set by adjusting a skew angle so as not to interfere with an adjacent track.
